(19) United States
(12) Patent Application Publication
(10) Pub. No.: US 2023/0393692 A1
(43) Pub. Date: Dec. 7, 2023

(54) A TOUCH SENSING APPARATUS

(71) Applicant: FLATFROG LABORATORIES AB, Lund (SE)

(72) Inventor: Mattias KRUS, Lund (SE)

(21) Appl. No.: 18/249,217

(22) PCT Filed: Oct. 15, 2021
(86) PCT No.: PCT/SE2021/051018

§ 371 Date: Apr. 14, 2023

(30) Foreign Application Priority Data
Oct. 19, 2020 (SE) 2030315-2

(51) Int. Cl. G06F 3/042

(52) U.S. Cl. CPC G06F 3/042

(57) ABSTRACT

The present disclosure relates to a touch sensing apparatus including a frame (2) comprising a first frame profile (21), a second frame profile (22), a third frame profile (23), and a fourth frame profile (24), wherein the first frame profile (21) and the second frame profile (22) form long sides of the frame (2), and the third frame profile (23) and the fourth frame profile form short sides of the frame (2), a front cover (3) arranged on the frame (2), the front cover (3) having a front surface (3a) and a rear surface, a display panel arranged on the frame (2), and a plurality of detectors arranged on first frame profile (21), and a plurality of emitters arranged on the second frame profile (22), wherein at least a portion of the first frame profile (21) and at least a portion of the second frame profile (22) are adapted to act on the front cover (3) with a force in a first direction parallel with a normal of the front surface (3a) of the front cover (3), and wherein at least a portion of the third frame profile (23) and at least a portion of the fourth frame profile (24) are adapted to act on the front cover (3) with a force in a second direction, opposite the first direction.

### TECHNICAL FIELD

Embodiments of the present disclosure relate to a touch sensing apparatus.

### TECHNICAL BACKGROUND

Touch sensing apparatuses, known as ‘above surface optical touch systems’, comprise a front cover forming a touch surface, a frame arranged along a periphery of the front cover, and a display panel arranged behind the front cover in a display support. The display panel may comprise one or more display sheets. The display sheets forming the display panel are manufactured from various layer, such as polarizing films, LCD module, optical film, light guide path, backlight etc. The various layers of the display panel are arranged in a display support. The display support, which may also be referred to as a back cover or external frame, is attached to the frame. The frame may be formed of several frame profiles, which may circumscribe the front cover.

A set of optical emitters adapted to emit light that is reflected to travel above the front cover is arranged in the frame. A set of light detectors adapted to receive light from the set of optical emitters above the front cover is arranged in the frame. The optical emitters and the light detectors may be intermittently arranged in the frame to improve the accuracy of the touch sensing functionality.

Various configurations of attachments of the front cover to the frame such as using adhesives have been used to secure the front cover to the frame.

### SUMMARY

It is an object of at least embodiments of the present disclosure to provide an improvement over the above described techniques and known art.

According to a first aspect of the present disclosure, a touch sensing apparatus is provided. The touch sensing apparatus comprises a frame comprising a first frame profile, a second frame profile, a third frame profile, and a fourth frame profile, wherein the first frame profile and the second frame profile form long sides of the frame, and the third frame profile and the fourth frame profile form short sides of the frame, a front cover arranged on the frame, the front cover having a front surface and a rear surface, a display panel arranged on the frame, and a plurality of detectors arranged on first frame profile, and a plurality of emitters arranged on the second frame profile, wherein at least a portion of the first frame profile and at least a portion of the second frame profile are adapted to act on the front cover with a force in a first direction parallel with a normal of the front surface of the front cover, and wherein at least a portion of the third frame profile and at least a portion the fourth frame profile are adapted to act on the front cover with a force in a second direction, opposite the first direction.

The second direction may be directed away from the front surface of the front cover.

The front cover may be concavely curved as seen from the front surface of the front cover.

The front cover may be concavely curved along a short side of the front cover as seen from the front surface of the front cover.

The front cover may be concavely curved along a long side of the front cover as seen from the front surface of the front cover.

The front cover may be arranged in a groove in the first frame profile.

The front cover may be clamped between a sealing and the second frame profile.

The third frame profile may contact the rear surface of the front cover.

The fourth frame profiles may contact the rear surface of the front cover.

The first frame profile may be free from emitters.

The second frame profile may be free from detectors.

The third frame profile may be free from detectors and free from emitters.

The fourth frame profile may be free from detectors and free from emitters.

The detectors may be arranged in the first frame profile with a mean distance between adjacent detectors exceeding 10 mm, preferably exceeding 15 mm, more preferably exceeding 20 mm. The mean distance between adjacent detectors may be in the range of 10-30 mm, preferably in the range of 10-20 mm.

The emitters may be arranged in the second frame profile with a mean distance between adjacent emitters exceeding 10 mm, preferably exceeding 15 mm, more preferably exceeding 20 mm. The mean distance between adjacent emitters may be in the range of 10-30 mm, preferably in the range of 10-20 mm.

The third frame profile may act on the front cover with a first force on a portion of the front cover adjacent the first frame profile, and the third frame profile may act on the front cover with a second force on a central portion of the front cover, wherein the first force may be exceeding the second force.

The third frame profile may act on the front cover with a first force on a portion of the front cover adjacent the second frame profile, and the third frame profile may act on the front cover with a second force on a central portion of the front cover, wherein the first force may be exceeding the second force.

The fourth frame profile may act on the front cover with a first force on a portion of the front cover adjacent the first frame profile, and the fourth frame profile may act on the front cover with a second force on a central portion of the front cover, wherein the first force may be exceeding the second force.

The fourth frame profile may act on the front cover with a first force on a portion of the front cover adjacent the second frame profile, and the fourth frame profile may act on the front cover with a second force on a central portion of the front cover, wherein the first force may be exceeding the second force.

The third frame profile may be curved. The third frame profile may be curved along its longitudinal direction.

The fourth frame profile may be curved. The fourth frame profile may be curved along its longitudinal direction.

The first frame profile may be curved. The first frame profile may be curved along its longitudinal direction.

The second frame profile may be curved. The second frame profile may be curved along its longitudinal direction.

The first frame profile and the second frame profile may be according to the fifth aspect of the disclosure described above.

The first frame profile may be according to the second aspect of the disclosure described below.

The first frame profile may be according to the third aspect of the disclosure described below.

According to a second aspect of the present disclosure, a touch sensing apparatus is provided. The touch sensing apparatus comprises a frame comprising a first frame profile, a second frame profile, a third frame profile, and a fourth frame profile, wherein the first frame profile and the second frame profile form long sides of the frame, and the third frame profile and the fourth frame profile form short sides of the frame, a front cover arranged on the frame, the front cover having a front surface and a rear surface, a display panel arranged on the frame, and a plurality of detectors arranged on first frame profile, and a plurality of emitters arranged on the second frame profile, wherein the first frame profile and the second frame profile are adapted to act on the front cover with a force in a first direction parallel with a normal of the front cover, and wherein the third frame profile and the fourth frame profile are adapted to act on the front cover with a force in the first direction in a central portion.

According to a third aspect of the present disclosure, a touch sensing apparatus is provided. The touch sensing apparatus comprises comprising a frame comprising at least a first frame profile, a front cover arranged on the frame, the front cover having a front surface and a rear surface, a plurality of optical components arranged on the first frame profile, the optical component comprising at least one of an emitter and/or a detector, a reflector surface arranged on the first frame profile, wherein the optical components are arranged at different distances from the reflector surface on the first frame profile.

The optical components may be arranged below the front surface of the front cover. Below is understood to mean below in a direction parallel to a normal of the front surface of the front cover.

The distance between the optical components and the reflector surface may vary along the first frame profile.

The first frame profile may be provided with multiple attachments positions for the optical components, wherein the attachments positions may be positioned at different distances from the reflector surface.

At least one of the optical components may be arranged in the first frame profile at a distance from the reflector surface exceeding 20 mm, preferably exceeding 25 mm, more preferably exceeding 40 mm.

A first set of the optical components may be arranged in the first frame profile at a distance from the reflector surface equal to or less than 20 mm, and a second set of the optical components may be arranged in the first frame at a distance from the reflector surface exceeding 20 mm.

The optical components may be arranged in the first frame profile with a mean distance between adjacent optical components exceeding 10 mm, preferably exceeding 15 mm, more preferably exceeding 20 mm. The mean distance between adjacent optical components may be in the range of 10-30 mm, preferably in the range of 10-20 mm.

When increasing the distance between adjacent optical component along the first frame profile, the distance from the reflector surface to the optical component may be increased.

The frame may further comprise a second frame profile, comprising a plurality of optical components. The optical component may comprise at least one of an emitter and/or a detector.

The optical components of the second frame profile may be arranged at different distances from a reflector surface on the second frame profile.

The second frame profile may be provided with a different type of optical component than the first frame profile.

At least one of the optical components may be arranged in the second frame profile at a distance from the reflector surface exceeding 20 mm, preferably exceeding 25 mm, more preferably exceeding 40 mm.

A first set of the optical components may be arranged in the second frame profile at a distance from the reflector surface equal to or less than 20 mm, and a second set of the optical components may be arranged in the second frame at a distance from the reflector surface exceeding 20 mm.

The optical components may be arranged in the second frame profile with a mean distance between adjacent optical components exceeding 10 mm, preferably exceeding 15 mm, more preferably exceeding 20 mm. The mean distance between adjacent optical components may be in the range of 10-30 mm, preferably in the range of 10-20 mm.

The optical components arranged in the first frame profile may be detectors.

The optical components arranged in the second frame profile may be emitters.

The first frame profile may be free from emitters.

The second frame profile may be free from detectors.

The optical components may be arranged on printed circuit boards arranged in the first frame profile, wherein each printed circuit boards may be provided with one or more of said optical components.

The optical components may be arranged on different positions on the printed circuit boards, such that the optical components may be arranged at different distances from the reflector surface on the first frame profile.

More than one optical component may be arranged on each printed circuit board, and the optical component may be arranged on different positions on the printed circuit board. Thereby, optical component may be arranged on a common printed circuit board at different distances from the reflector surface on the first frame profile.

Adjacent optical components may be connected to each other by a vertical board to board connector.

The first frame profile may comprise a stamped sheet metal component, wherein the optical components are arranged on said sheet metal component at a contiguous and variable distance from the reflector surface.

The frame may further comprise a third frame profile and a fourth frame profile.

The third frame profile and the fourth frame profile may form short sides of the frame.

The third frame profile and the fourth frame profile may be free from emitters.

The third frame profile and the fourth frame profile may be free from detectors.

The first frame profile and the second frame profile may be according to the fifth aspect of the disclosure described above.

The first frame profile, the second frame profile, the third frame profile, and the fourth frame profile may be according to the first aspect of the disclosure described above.

The first frame profile may be according to the third aspect of the disclosure described below.

In one example, a touch sensing apparatus is provided. The touch sensing apparatus comprises comprising a frame comprising at least a first frame profile, a front cover arranged on the frame, the front cover having a front surface and a rear surface, a plurality of optical components arranged on the first frame profile, the optical component comprising at least one of an emitter and/or a detector, a reflector surface arranged on the first frame profile, wherein a first optical component, or a first set of optical components, is arranged at a first distance from the reflector surface on the first frame profile, and at least a second optical component, or a second set of said optical components, is arranged at a second distance from the reflector surface on the first frame profile, wherein the first distance exceeds the second distance.

The first optical component, or the first set of optical components, may provide a wider scanline than the second optical component or the second set of optical components.

The first optical component, or the first set of optical components, may perform a detect scan. If a touch is detected, the second optical component, or the second set of optical components, is triggered to perform a scan in the region of the first optical component. The scan of the second optical component, or the second set of optical components, may be performed with scanlines being narrow compared to scanlines of the first optical component, or the first set of optical components.

The first optical component may be arranged subsequently a number of second set of optical components along the first frame profile. The first optical component may be positioned after a predetermined number of second optical components, for example after every 5^{th} second optical components.

According to a fourth aspect of the present disclosure, a touch sensing apparatus is provided. The touch sensing apparatus comprise a frame comprising at least a first frame profile, a front cover arranged on the frame by the first frame profile, the front cover having a front surface and a rear surface, a display panel arranged on the frame, and a plurality of optical components arranged on first frame profile, the optical component comprising at least one of an emitter and/or a detector, and wherein the first frame profile comprises a reflector surface having at least one specular reflector portion and at least one diffuser reflector portion.

The optical components may be arranged below the front surface of the front cover. Below is understood to mean below in a direction parallel to a normal of the front surface of the front cover.

A ratio between a number of specular reflector portions to a number of optical components may be in the range of 1:5-1:50.

A ratio between a number of diffuser reflector portions to a number of optical components may be in the range of 4:5-49:50.

The specular reflector portions and the diffuser reflector portions may be intermittently arranged in the reflector surface.

At least one of said specular reflector portions may be arranged in the first frame profile adjacent a corner of the frame.

The optical components arranged in the first frame profile may be detectors.

The frame may further comprise a second frame profile, comprising a plurality of optical components. The optical component may comprise at least one of an emitter and/or a detector.

The second frame profile may comprise a reflector surface having at least one specular reflector portion and at least one diffuser reflector portion.

The optical components arranged in the second frame profile may be emitters.

At least one of said specular reflector portions may be arranged in the second frame profile adjacent a corner of the frame.

The first frame profile may be free from emitters.

The frame profile may be free from detectors.

The first frame profile and the second frame profile may form long sides of the frame.

The optical components may be arranged in the first frame profile with a mean distance between adjacent optical components exceeding 10 mm, preferably exceeding 15 mm, more preferably exceeding 20 mm. The mean distance between adjacent optical components may be in the range of 10-30 mm, preferably in the range of 10-20 mm.

The optical components may be arranged in the second frame profile with a mean distance between adjacent optical components exceeding 10 mm, preferably exceeding 15 mm, more preferably exceeding 20 mm. The mean distance between adjacent optical components may be in the range of 10-30 mm, preferably in the range of 10-20 mm.

According to a fifth aspect of the present disclosure, a touch sensing apparatus is provided. The touch sensing apparatus comprises a frame comprising at least a first frame profile and a second frame profile, wherein the first frame profile and the second frame profile are oppositely arranged, a front cover arranged on the frame by the first frame profile and the second frame profile, the front cover having a front surface and a rear surface, a display panel arranged on the frame, and a plurality of detectors arranged on first frame profile, and a plurality of emitters arranged on the second frame profile, wherein the first frame profile comprises a first frame lip, and the second frame profile comprises a second frame lip, and wherein a first cover distance parallel to a normal to the front surface of the front cover from the first frame lip to the front surface of the front cover is exceeding a second cover distance parallel to a normal to the front surface of the front cover from the second frame lip to the front surface of the front cover.

A sealing may be arranged between the front surface of the front cover and the second frame profile.

The front cover may be clamped between the second frame profile and the sealing.

The front cover may be arranged in a groove in the first frame profile.

An open aperture may be provided in the first frame profile from the first frame lip to a part of the first frame profile enclosing the front cover in a direction normal to the front surface of the front cover.

The first frame profile and the second frame profile may form long sides of the frame.

The first frame profile may be free from emitters.

The second frame profile may be free from detectors.

The detectors may be arranged in the first frame profile with a mean distance between adjacent detectors exceeding 10 mm, preferably exceeding 15 mm, more preferably exceeding 20 mm. The mean distance between adjacent detectors may be in the range of 10-30 mm, preferably in the range of 10-20 mm.

The emitters may be arranged in the second frame profile with a mean distance between adjacent emitters exceeding 10 mm, preferably exceeding 15 mm, more preferably exceeding 20 mm. The mean distance between adjacent emitters may be in the range of 10-30 mm, preferably in the range of 10-20 mm.

The frame may further comprise a third frame profile and a fourth frame profile.

The third frame profile and the fourth frame profile may form short sides of the frame.

The third frame profile and the fourth frame profile may be free from emitters.

The third frame profile and the fourth frame profile may be free from detectors.

The first frame profile, the second frame profile, the third frame profile, and the fourth frame profile may be according to the first aspect of the disclosure described below.

The first frame profile may be according to the second aspect of the disclosure described below.

The first frame profile may be according to the third aspect of the disclosure described below.

According to an example of an embodiment of the fifth aspect, the touch sensing apparatus comprises no display panel. According to the example, a touch sensing apparatus is provided, comprising a frame comprising at least a first frame profile and a second frame profile, wherein the first frame profile and the second frame profile are oppositely arranged, a front cover arranged on the frame by the first frame profile and the second frame profile, the front cover having a front surface and a rear surface, and a plurality of detectors arranged on first frame profile, and a plurality of emitters arranged on the second frame profile, wherein the first frame profile comprises a first frame lip, and the second frame profile comprises a second frame lip, and wherein a first cover distance parallel to a normal to the front surface of the front cover from the first frame lip to the front surface of the front cover is exceeding a second cover distance parallel to a normal to the front surface of the front cover from the second frame lip to the front surface of the front cover.

According to a sixth aspect of the present disclosure, a touch sensing apparatus is provided. The touch sensing apparatus comprises a frame comprising at least a first frame profile, a front cover arranged on the frame by the first frame profile, the front cover having a front surface and a rear surface, a display panel arranged on the frame, and a plurality of optical components arranged on first frame profile, the optical component comprising at least one of an emitter and a detector, and wherein the first frame profile comprises a reflector surface comprising at least one specular reflector portion and at least one diffuser reflector portion, wherein at least one optical component is arranged above the front surface of the front cover, and at least two optical components are arranged below the front surface of the front cover, said at least two optical components are arranged below the front surface of the front cover at a varying distance from the reflector surface.

The frame may further comprise a third frame profile and a fourth frame profile.

The third frame profile and the fourth frame profile may form short sides of the frame.

The third frame profile and the fourth frame profile may be free from emitters.

The third frame profile and the fourth frame profile may be free from detectors.

The first frame profile and the second frame profile may be according to the fifth aspect of the disclosure described above.

The first frame profile, the second frame profile, the third frame profile, and the fourth frame profile may be according to the first aspect of the disclosure described above.

The first frame profile may be according to the second aspect of the disclosure described above.

All aspects of the present disclosure described above may be combined.

### BRIEF DESCRIPTION OF THE DRAWINGS

The present disclosure will by way of example be described in more detail with reference to the appended schematic drawings, which show examples of the present disclosure.

FIG. 1 shows a front view of a touch sensing apparatus.

FIG. 2A shows a cross section of the touch sensing apparatus shown in FIG. 1.

FIG. 2B shows a cross section of an alternative example of the touch sensing apparatus shown in FIG. 1.

FIG. 3 shows a perspective view of a touch sensing apparatus.

FIG. 4 shows a first cross section of the touch sensing apparatus shown in FIG. 3.

FIG. 5 shows a second cross section of a touch sensing apparatus shown in FIG. 3.

FIG. 6A shows a cross section of a first frame profile of a touch sensing apparatus.

FIG. 6B shows a cross section of a first frame profile of a touch sensing apparatus.

FIG. 7A shows an arrangement of optical components in a first frame profile of a touch sensing apparatus.

FIG. 7B shows an arrangement of optical components in a first frame profile of a touch sensing apparatus.

FIG. 7C shows an arrangement of optical components in a first frame profile of a touch sensing apparatus.

FIG. 7D shows an arrangement of optical components in a first frame profile of a touch sensing apparatus.

FIG. 8A shows an arrangement of reflector surfaces and optical components in a first frame profile of a touch sensing apparatus.

FIG. 8B shows an arrangement of reflector surfaces and optical components in a first frame profile of a touch sensing apparatus.

### DETAILED DESCRIPTION

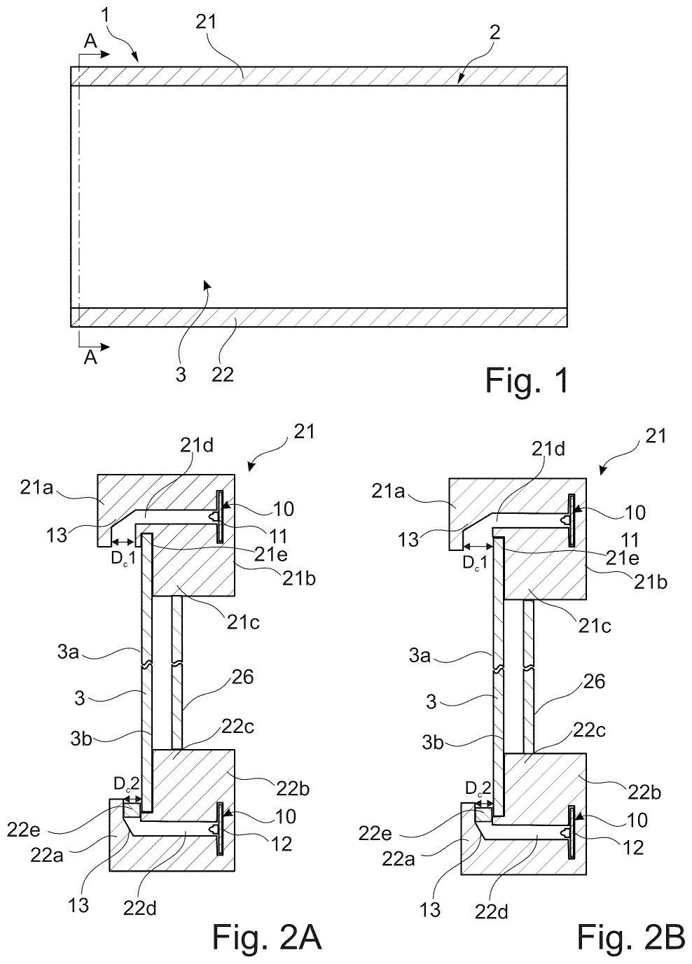

FIG. 1 shows a touch sensing apparatus 1. The touch sensing apparatus 1 comprises a frame 2. The frame 2 comprises at least a first frame profile 21 and a second frame profile 22. The frame 2 may further comprise a third frame profile 23 (not visible in FIG. 1) and a fourth frame profile 24 (not visible in FIG. 1). The first frame profile 21 and the second frame profile 22 are oppositely arranged. The third frame profile 23 and the fourth frame profile 24 may be oppositely arranged. The first frame profile 21, the second frame profile 22, the third frame profile 23, and the fourth frame profile 24 may be connected to each other at corners of the frame 2.

The first frame profile 21 may be an extruded profile, such as an extruded metal profile, for example an extruded aluminium profile. The second frame profile 22 may be an extruded profile, such as an extruded metal profile, for example an extruded aluminium profile. The third frame profile 23 may be an extruded profile, such as an extruded metal profile, for example an extruded aluminium profile. The fourth frame profile 24 may be an extruded profile, such as an extruded metal profile, for example an extruded aluminium profile.

The touch sensing apparatus 1 further comprises a front cover 3. The front cover 3 has a front surface 3a and a rear surface 3b. When the touch sensing apparatus 1 being used, the front surface 3a of the front cover 3 is adapted to face a user of the touch sensing apparatus 1. The front surface 3a of the front cover 3 is adapted to form the surface which a user of the touch sensing apparatus 1 interacts with.

The front cover 3 is arranged in the frame 2 by the first frame profile 21 and the second frame profile 22. The first frame profile 21 and the second frame profile 22 may be arranged long edges of the front cover 3.

The touch sensing apparatus 1 may have a rectangular shape. Consequently, the front cover 3 may have a rectangular shape. The front cover 3 may have two oppositely arranged long sides and two oppositely arranged short sides. The first frame profile 21 may be attached to a first long side of the front cover 3. The second frame profile 22 may be attached to a second long side of the front cover 3. When the touch sensing apparatus 1 is in use, for example, attached to a wall, the first long side of the front cover 3 may form an upper side of the front cover 3, and the second long side of the front cover 3 may form a lower side of the front cover 3.

In order to provide the touch sensing functionality, a plurality of optical components 10 such as detectors 11 and emitters 12 is arranged in the frame 2. In the first frame profile 21, a plurality of detectors 11 is arranged. In the second frame profile 22, a plurality of emitters 12 is arranged.

The detectors 11 may be arranged adjacent each other along a longitudinal direction of the first frame profile 21. The detectors 11 may be arranged in the first frame profile 21 with a mean distance between adjacent detectors 11 exceeding 10 mm, preferably exceeding 15 mm, more preferably exceeding 20 mm. The mean distance between adjacent detectors 11 may be in the range of 10-30 mm, preferably in the range of 10-20 mm.

The emitters 12 may be arranged adjacent each other along a longitudinal direction of the second frame profile 22. The emitters 12 may be arranged in the second frame profile 22 with a mean distance between adjacent emitters 12 exceeding 10 mm, preferably exceeding 15 mm, more preferably exceeding 20 mm. The mean distance between adjacent emitters 12 may be in the range of 10-30 mm, preferably in the range of 10-20 mm.

The first frame profile 21 may be free from any emitters. The second frame profile 22 may be free from any detectors. Consequently, a first side of the touch sensing apparatus 1 may only be provided with detectors 11 and no emitters, and a second side of the touch sensing apparatus 1 may only be provided with emitters 12 and no detectors.

In one example, the first frame profile 21 may comprise emitters 12 and detectors. The emitters 12 and the detectors may be intermittently arranged in the first frame profile 21. The second frame profile 22 may comprise emitters and detectors 11. The emitters and the detectors 11 may be intermittently arranged in the second frame profile 22.

The touch sensing apparatus 1 further comprises a display panel (not visible in FIG. 1) arranged in the frame 2. The display panel may comprise one or more display sheets.

FIGS. 2A and 2B shows a cross section of the touch sensing apparatus 1 along line A-A in FIG. 1. FIGS. 2A and 2B shows the first frame profile 21 and the second frame profile 22 in cross section. The first frame profile 21 may be an upper frame profile. The second frame profile 22 may be a lower frame profile.

As seen in FIG. 2A, the first frame profile 21 comprises a first frame lip 21a, a first frame rear portion 21b, and a first frame central portion 21c. An aperture 21d is formed between the first frame lip 21a and the first frame central portion 21c. As shown in the cross section in FIG. 2A, a detector 11 is arranged on the first frame rear portion 21b of the first frame profile 21. The first frame profile 21 may be provided with at least one reflector surface 13. The aperture 21d may be extending from the detector 11 to in front of the front surface 3a of the front cover 3, as seen in a direction normal to the front cover 3.

As seen in cross section, the first frame lip 21a has a first part protruding in a direction normal to the front surface 3a of the front cover 3, away from the first frame rear portion 21b. The first frame lip 21a has a second part protruding downwardly, in respect to the directions in FIG. 2A, from the first part, in a direction parallel to the front surface 3a of the front cover 3. The second part of the first frame lip 21a is protruding towards the second frame lip 22a, as seen in cross section.

The front cover 3 may be arranged in a groove 21e in the first frame profile 21. The groove 21e may be arranged in the first frame central portion 21c of the first frame profile 21. The front cover 3 may be clamped in the first frame central portion 21c of the first frame profile 21. As an alternative, the front cover 3 may be attached to the first frame profile 21 by an adhesive, which will be described above with reference to FIG. 2B.

The second frame profile 22 comprises a second frame lip 22a, a second frame rear portion 22b, and a second frame central portion 22c. An aperture 22d is formed between the second frame lip 22a and the second frame central portion 22c. As shown in the cross section in FIG. 2A, an emitter 12 is arranged on the second frame rear portion 22b of the second frame profile 22. The second frame profile 22 may be provided with at least one reflector surface 13.

As seen in cross section, the second frame lip 22a has a first part protruding in a direction normal to the front surface 3a of the front cover 3, away from the second frame rear portion 22b. The second frame lip 22a has a second part protruding upwardly, in respect to the directions in FIG. 2A, from the first part, in a direction parallel to the front surface 3a of the front cover 3. The second part of the second frame lip 22a is protruding towards the first frame lip 21a, as seen in cross section.

A sealing 22e may be arranged in the second frame aperture 22d between the second frame lip 22a and the front surface 3a of the front cover 3. The front cover 3 may be clamped between the sealing 22e and the second frame central portion 22c of the second frame profile 22. In an example, the sealing 22e may comprise extruded polymethyl methacrylate (PMMA). The sealing 22e may be transparent to wavelengths of light emitted by emitters 12. The sealing 22e at least partly prevents dust and similar to enter into the touch sensing apparatus 1.

In one example, no sealing is provided in the second frame aperture 22d between the second frame lip 22a and the front surface 3a of the front cover 3.

The display panel 26 is arranged on the frame 2 by at least the first frame profile 21 and the second frame profile 22.

A first cover distance D_{c}1 parallel to a normal to the front surface 3a of the front cover 3 from the first frame lip 21a to a portion of the first frame profile 21 adjacent the front surface 3a of the front cover is exceeding a second cover distance D_{c}2 parallel to a normal to the front surface 3a of the front cover 3 from the second frame lip 22a the front surface 3a of the front cover 3.

The first cover distance D_{c}1 may be measured from a portion of the first frame profile 21 clamping the front cover 3 to a portion of the first frame lip 21a facing the front surface 3a of the front cover 3. The second cover distance D_{c}2 may be measured from the front surface 3a of the front cover 3 to a portion of the second frame lip 22a facing the front surface 3a of the front cover 3.

In other words, the first cover distance D_{c}1 may be described as the shortest distance between the first frame lip 21a and the front surface 3a of the front cover 3. The second cover distance D_{c}2 may be described as the shortest distance between the second frame lip 22a and the front surface 3a of the front cover 3. The shortest distance between the first frame lip 21a and the front surface 3a of the front cover 3 is exceeding the shortest distance between the second frame lip 22a and the front surface 3a of the front cover 3.

The first cover distance D_{c}1 may be 2-6 mm. The second cover distance D_{c}2 may be 1-3 mm.

In FIG. 2B, the front cover 3 is attached to the first frame profile 21 by, for example, an adhesive. In this example, the first cover distance D_{c}1 is measured from the first frame lip 21a to the front surface 3a of the front cover 3, in a direction parallel to a normal to the front surface 3a of the front cover 3. In all other aspects, the touch sensing apparatus 1 in FIG. 2B corresponds to the touch sensing apparatus 1 described above with reference to in FIG. 2A.

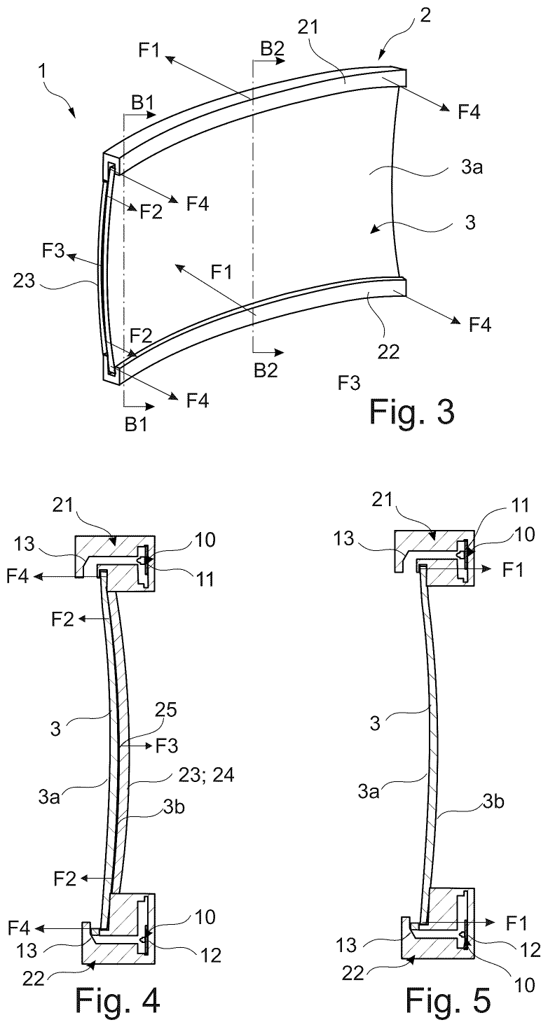

FIG. 3 shows a touch sensing apparatus 1. The touch sensing apparatus 1 comprises a frame 2. The frame 2 comprises at least a first frame profile 21 and a second frame profile 22, a third frame profile 23 and a fourth frame profile 24 (not visible in FIG. 3). The first frame profile 21 and the second frame profile 22 are oppositely arranged. The third frame profile 23 and the fourth frame profile 24 are oppositely arranged. The first frame profile 21, the second frame profile 22, the third frame profile 23, and the fourth frame profile 24 be connected to each other at corners of the frame 2.

The first frame profile 21 may be an extruded profile, such as an extruded metal profile, for example an extruded aluminium profile. The second frame profile 22 may be an extruded profile, such as an extruded metal profile, for example an extruded aluminium profile. The third frame profile 23 may be an extruded profile, such as an extruded metal profile, for example an extruded aluminium profile. The fourth frame profile 24 may be an extruded profile, such as an extruded metal profile, for example an extruded aluminium profile.

The touch sensing apparatus 1 further comprises a front cover 3. The front cover 3 has a front surface 3a and a rear surface 3b. When the touch sensing apparatus 1 being used, the front surface 3a of the front cover is adapted to face an user of the touch sensing apparatus 1. The front surface 3a of the front cover 3 is adapted to form the surface which a user of the touch sensing apparatus 1 interacts with.

The front cover 3 is arranged on the frame 2 by at least the first frame profile 21, the second frame profile 22. The front cover 3 is in contact with the third frame profile 23 and the fourth frame profile 24.

The touch sensing apparatus 1 may have a rectangular shape. Consequently, the front cover 3 may have a rectangular shape. The front cover 3 may have two oppositely arranged long sides and two oppositely arranged short sides. The first frame profile 21 may be attached to a first long side of the front cover 3. The second frame profile 22 may be attached to a second long side of the front cover 3. The third frame profile 23 profile may be attached to a first short side of the front cover 3. The fourth frame profile 24 may be attached to a second short side of the front cover 3.

When the touch sensing apparatus 1 is in use, for example, attached to a wall, the first long side of the front cover 3 may form an upper side of the front cover 3, and the second long side of the front cover 3 may form a lower side of the front cover 3.

In order to provide the touch sensing functionality, a plurality of optical components 10 such as detectors 11 and emitters 12 is arranged in the frame 2. In the first frame profile 21, a plurality of detectors 11 are arranged. In the second frame profile 22, a plurality of emitters 12 are arranged.

The detectors 11 may be arranged adjacent each other along a longitudinal direction of the first frame profile 21. The detectors 11 may be arranged in the first frame profile 21 with a mean distance between adjacent detectors 11 exceeding 10 mm, preferably exceeding 15 mm, more preferably exceeding 20 mm. The mean distance between adjacent detectors 11 may be in the range of 10-30 mm, preferably in the range of 10-20 mm.

The emitters 12 may be arranged adjacent each other along a longitudinal direction of the second frame profile 22. The emitters 12 may be arranged in the second frame profile 22 with a mean distance between adjacent emitters 12 exceeding 10 mm, preferably exceeding 15 mm, more preferably exceeding 20 mm. The mean distance between adjacent emitters 12 may be in the range of 10-30 mm, preferably in the range of 10-20 mm.

The first frame profile 21 may be free from any emitters. The second frame profile 22 may be free from any detectors. Consequently, a first long side of the touch sensing apparatus 1 may only be provided with detectors 11 and no emitters, and a second long side of the touch sensing apparatus 1 may only be provided with emitters 12 and no detectors.

In one example, the first frame profile 21 may comprise emitters 12 and detectors. The emitters 12 and the detectors may be intermittently arranged in the first frame profile 21. The second frame profile 22 may comprise emitters and detectors 11. The emitters and the detectors 11 may be intermittently arranged in the second frame profile 22.

The first frame profile 21 and the second frame profile 22 may be provided with at least one reflector surface 13 each.

The first frame profile 21 and the second frame profile 22 may have the configuration shown in FIGS. 1-2, wherein a first cover distance D c 1 parallel to a normal to the front surface 3a of the front cover 3 from the first frame lip 21a to the front surface 3a of the front cover 3 is exceeding a second cover distance D c 2 along a normal to the front surface 3a of the front cover 3 from the second frame lip 22a the front surface 3a of the front cover 3.

The third frame profile 23 may be connected to the first frame profile 21 and to the second frame profile 22 at its distal ends. The fourth frame profile 24 may be connected to the first frame profile 21 and to the second frame profile 22 at its distal ends.

The third frame profile 23 may be free from detectors and emitters.

The fourth frame profile 24 may be free from detectors and emitters.

The touch sensing apparatus 1 further comprises a display panel (not visible in FIG. 3) arranged in the frame 2. The display panel may comprise one or more display sheets.

As shown in FIGS. 3-5, the front cover 3 is curved. The front cover 3 is concavely curved as seen from the front surface 3a of the front cover 3.

The curvature of the front cover 3 is shown in more details in FIG. 4 and in FIG. 5. FIG. 4 shows a cross section of the touch sensing apparatus 1 in FIG. 3 along section B1-B1. FIG. 5 shows a cross section of the touch sensing apparatus 1 in FIG. 3 along section B2-B2. As previously described, the front cover 3 is concavely curved as seen from the front surface 3a of the front cover 3.

As an example, the third frame profile 23 is similar to the fourth frame profile 24, such that a cross-section B1-B1 of the third frame profile 23 is similar to a cross-section of the fourth frame profile 24.

As seen in FIG. 3, the curvature of the front cover 3 along the first frame profile 21 and the second frame profile 22 is provided by the first frame profile 21 and the second frame profile 22 act on the front cover 3 with a force in a first direction at distal ends of the first frame profile 21 and of the second frame profile 22, respectively. At a centre portion of the first frame profile 21 and at a centre portion of the second frame profile 22, the first frame profile 21 and the second frame profile 22 act on the front cover 3 with a force in a second direction, opposite the first direction. The first frame profile 21 and the second frame profile 22 act on the front cover 3 with a pushing force F4 in a first direction parallel with a normal of the front surface 3a of the front cover 3 at the distal ends of the first frame profile 21 and of the second frame profile 22, respectively. The first direction is directed away from the front surface 3a of the front cover 3. The first frame profile 21 and the second frame profile 22 act on the front cover 3 with a pulling force F1 in a second direction, opposite the first direction, at the centre portion of the first frame profile 21 and of the second frame profile 22, respectively. The second direction is parallel with a normal of the front surface 3a of the front cover 3. The second direction is directed into the front cover 3. The second direction is directed away from the rear surface 3b of the front cover 3.

In FIG. 5, showing a cross section of the touch sensing apparatus along line B1-B1 in FIG. 3, the pulling force F1 at the centre portion of the first frame profile 21 and at the centre portion of the second frame profile 22 is shown.

In FIGS. 3 and 4, the curvature of the front cover 3 along the third frame profile 23 and the fourth frame profile 24 is shown. FIG. 4 illustrates a cross section along line B1-B1 in FIG. 3. The curvature of the front cover 3 is provided by at least the distal ends of the first frame profile 21 and of the second frame profile 22 act on the front cover 3 with a force in a first direction At least the distal ends of the third frame profile 23 and the fourth frame profile 24 act on the front cover 3 with a pushing force F2 in a first direction. The first direction is parallel with a normal of the front surface 3a of the front cover 3. The first direction is directed away from the front surface 3a of the front cover 3. The front cover 3 is arranged in a groove 21e in the first frame profile 21.

The front cover 3 may be arranged in the second frame profile 22 by being clamped between the second frame profile 22 and a sealing 22e.

The first frame profile 21 and the second frame profile 22 may have the configuration as described above with reference to FIGS. 1-2.

The first frame profile 21 may be curved along its longitudinal direction, as seen front the front surface 3a of the front cover 3.

The second frame profile 22 may be curved along its longitudinal direction, as seen front the front surface 3a of the front cover 3. The third frame profile 23 is adapted to act on the front cover 3 with the pushing force F2. At least a part of the third frame profile 23 may act on the front cover 3 with the pushing force F2. The fourth frame profile 24 is adapted to act on the front cover 3 with the pushing force F2. At least a part of the fourth frame profile 24 may act on the front cover 3 with the pushing force F2. The pushing force F2 acted by at least a portion of the third frame profile 23 and by at least a portion of the fourth frame profile 24 may be directed in a direction away from the front surface 3a of the front cover 3.

A surface of the third frame profile 23 may be in contact with at least a portion of the rear surface 3b of the front cover 3. The third frame profile 23 may act on the rear surface 3b of the front cover 3 with the pushing force F2 along at least a portion of the rear surface 3b of the front cover 3.

The third frame profile 23 may be located below the rear surface 3b of the front cover 3, such that the third frame profile 23 not being visible from the front surface 3a of the front cover 3. In contrast the first frame profile 21, the third frame profile 23 may not enclose the front cover 3.

The third frame profile 23 may be curved along its longitudinal direction, as seen front the front surface 3a of the front cover 3.

A surface of the fourth frame profile 24 may be in contact with at least a portion of the rear surface 3b of the front cover 3. The third frame profile 23 may act on the rear surface 3b of the front cover 3 with the pushing force F2 along at least a portion of the rear surface 3b of the front cover 3. The fourth frame profile 24 may be located below the rear surface 3b of the front cover 3, such that the fourth frame profile 24 not being visible from the front surface 3a of the front cover 3. In contrast the first frame profile 21, the fourth frame profile 24 may not enclose the front cover 3.

The fourth frame profile 24 may be curved along its longitudinal direction, as seen front the front surface 3a of the front cover 3.

In FIG. 4, the third frame profile 23 is adapted to act on the front cover 3 with a pulling force F3 at least on a central portion of the front cover 3. The pulling force F3 is directed parallel a normal to the rear surface 3b of the front cover 3. The pulling force may be directed away from the rear surface 3b of the front cover 3. The pulling force F3 may be obtained by the third frame profile 23 being attached to the rear surface 3b of the front cover 3 by an adhesive in a contact point 25.

Similarly, the fourth frame profile 24 is adapted to act on the front cover 3 with a pulling force F3 at least on a central portion of the front cover 3. The pulling force F3 is directed parallel a normal to the rear surface 3b of the front cover 3. The pulling force may be directed away from the rear surface 3b of the front cover 3. The pulling force F3 may be obtained by the fourth frame profile 24 being attached to the rear surface 3b of the front cover 3 by an adhesive in a contact point 25.

In another example (not shown), the third frame profile 23 may act on the front cover 3 with a first pushing force on a portion of the front cover 3 adjacent the first frame profile 21 and/or adjacent the second frame profile 22. The third frame profile 23 may act on the front cover 3 with a second pushing force on a central portion of the front cover 3. The first pushing force, applied adjacent the first frame profile 21 and/or the second frame profile 22 may be exceeding the second pushing force, applied on the central portion of the front cover 3.

Similarly, the fourth frame profile 24 may act on the front cover 3 with a first pushing force on a portion of the front cover 3 adjacent the first frame profile 21 and/or adjacent the second frame profile 22. The fourth frame profile 24 may act on the front cover 3 with a second pushing force on a central portion of the front cover 3. The first pushing force, applied adjacent the first frame profile 21 and/or the second frame profile 22 may be exceeding the second pushing force, applied on the central portion of the front cover 3.

The third frame profile 23 may be concavely curved along its longitudinal direction, as seen from the front surface 3a of the front cover 3.

The fourth frame profile 24 may be concavely curved along its longitudinal direction, as seen front the front surface 3a of the front cover 3.

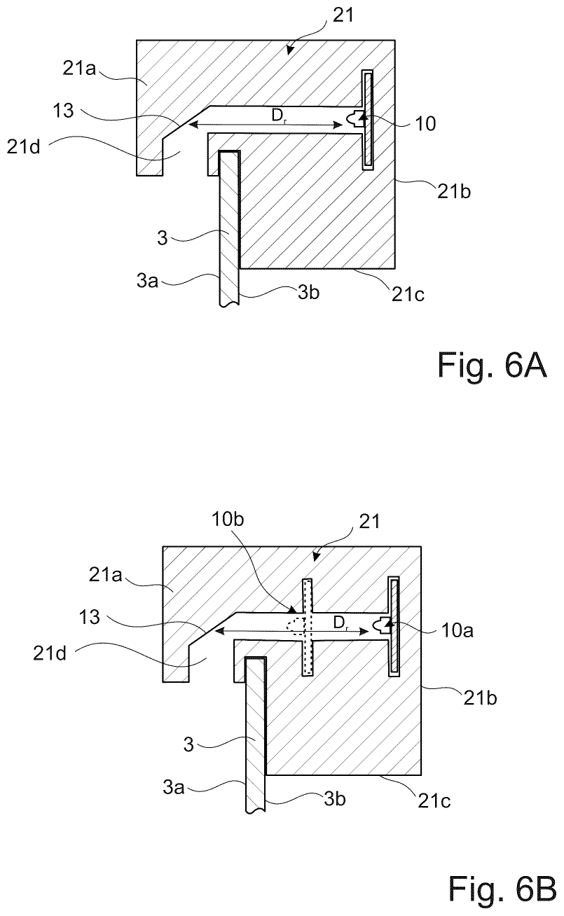

An embodiment of a touch sensing apparatus 1 will now be described with reference to FIGS. 6A and 6B. FIG. 6A shows a portion of a touch sensing apparatus 1, for example to the touch sensing apparatus 1 described above with reference to FIGS. 1-2, and/or the touch sensing apparatus 1 described above with reference to FIGS. 3-5.

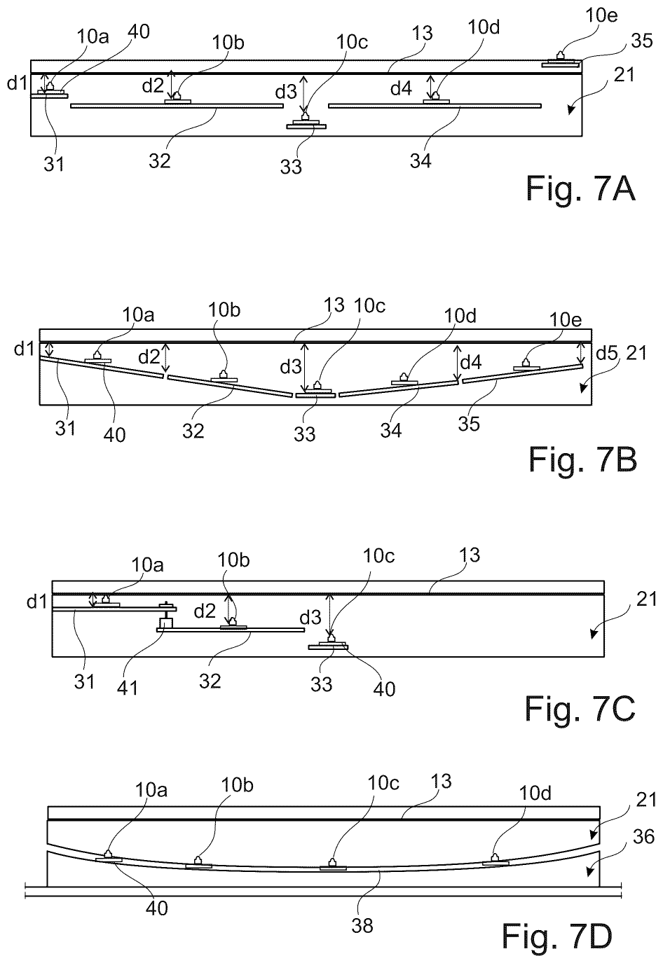

FIG. 6A shows a frame profile in cross section. In FIG. 6A, the first frame profile 21 is shown as the frame profile in cross section. However, the disclosure below with reference to the first frame profile 21 is applicable also for the second frame profile 22. In other words, the second frame profile 22 may replace the first frame profile 21 in the disclosure below with reference to FIGS. 6A and 7A-D.

As described above with reference to FIGS. 2A and 2B, the first frame profile 21 comprises a first frame lip 21a, a first frame rear portion 21b, and a first frame central portion 21c. An aperture 21d is formed between the first frame lip 21a and the first frame central portion 21c. An optical component 10 is arranged on the first frame rear portion 21b of the first frame profile 21. The first frame profile 21 may be provided with at least one reflector surface 13. The aperture 21d may be extending from the optical component 10 to in front of the front surface 3a of the front cover 3, as seen in a direction normal to the front cover 3.

Two or more optical components 10 are arranged on the first frame profile 21. The optical component 10 may be a detector 11 and/or an emitter 12. The optical components 10 are arranged along a longitudinal direction of the first frame profile 21.

The optical components 10 are arranged at a reflector distance Dᵣ from a reflector surface 13. The reflector distance Dᵣ between the optical component 10 and the reflector surface 13 may be exceeding 20 mm.

The optical components 10 such as the detectors 11 and/or emitters 12 may be arranged on a printed circuit board (PCB) 40. Each printed circuit board 40 may comprise one or more optical components 10. Adjacent printed circuit boards 40 may be connected to each other by a vertical board to board connector.

Along the longitudinal direction of the first frame profile 21, or along the second frame profile 22, the optical components 10 are arranged at different reflector distances Dᵣ from the reflector surface 13. The reflector distance Dᵣ between the optical components 10 and the reflector surface 13 varies along the longitudinal direction of the first frame profile 21, or along the second frame profile 22.

The optical components 10 can be arranged at different positions on the printed circuit board 40. The optical components 10 may be arranged at different reflector distances Dᵣ from the reflector surface 13 by being arranged at different positions on the printed circuit board 40. Several optical components 10 may be arranged on the same printed circuit board 40 but at different reflector distances Dᵣ from the reflector surface 13.

By varying the reflector distance Dr between the optical components 10 and the reflector surface 13, scanline width can be varied. Scanlines are understood to mean a grid of intersecting light paths emitted from emitters 12 and/or detectors 11. The scanline width affects touch performance factors such as detectability, accuracy, resolution, the presence of reconstruction artefacts. The scanline width is the width of the portion of light travelling from the emitter 12 to the detector 11 that can be used to detect an interrupting object between the emitter 12 and detector 11, wherein the width is measured perpendicular to the scanline direction. In the present disclosure, the broadening of a scanline is defined to mean the increase in scanline width. Therefore, through broader scanlines, the resolution and accuracy of the touch sensing apparatus 1 may thus be improved and the touch performance is increased.

By arranging the optical component 10 closer to the front cover 3, the scanline will be narrower. By arranging the optical component 10 at a longer distance from the reflector surface 13, the scanline will be wider.

At least one of the optical components 10 may be arranged in the first frame profile 21 at a reflector distance Dᵣ from the reflector surface 13 exceeding 2.5 mm, preferably exceeding 5 mm, more preferably exceeding 10 mm such as exceeding 15 mm. In one example, the reflector distance Dᵣ may be in the range of 2.5-7.5 mm. In another example, the reflector distance Dᵣ may be in the range of 10-30 mm.

As an example, a first set of optical components 10 may be arranged at a reflector distance Dᵣ from the reflector surface 13 equal or less than 10 mm, and a second set of the optical components 10 may be arranged at a reflector distance Dᵣ from the reflector surface 13 exceeding 10 mm. Thereby, the scanline width of the first set of optical components 10 is different in respect of the scanline width of the second set of optical components 10. The further distance from the reflector surface 13, the wider scanline is provided.

A mean distance between adjacent optical components 10 along the longitudinal extension of the first frame profile 21 may be exceeding 10 mm, preferably exceeding 15 mm, more preferably exceeding 20 mm. The mean distance between adjacent optical components 10 may be in the range of 10-30 mm, preferably in the range of 10-20 mm.

The scanline width may change according to optical component density and vice versa. By optical component density is intended number of optical components 10 per length unit. If adjacent optical components 10 are arranged at a longer distance between each other, the scanline width can be increased by positioning the optical components at an increased distance from the reflector distance Dᵣ.

The distance between adjacent optical components 10 may depend on the reflector distance Dᵣ, and vice versa. Optical components 10 arranged at a longer distance between each other, such as exceeding 20 mm, may be arranged at an increased reflector distance Dᵣ, such as a reflector distance Dᵣ exceeding 5 mm.

Varying the scanline width may also be used to perform a detect scan. A first of said optical components 10, or a first set of said optical components 10, may be configured to perform a detect scan by using wide scanlines. If a touch is detected, a second of said optical components 10, or a second set of optical components 10, positioned in the area of the detected touch, are activated to perform a scan by using narrow scanlines.

The first of said optical component, or the first set of said optical components 10, may be arranged at a first reflector distance Dᵣ. The second of said optical component, or the second set of said optical components 10, may be arranged at a second reflector distance Dᵣ. The first reflector distance Dᵣ may exceed the second reflector distance Dᵣ. Thereby, the first of said optical component, or the first set of said optical components 10, has a wider scanline than the second of said optical component, or the second set of said optical components 10.

The first of said optical component 10 may positioned along the first frame profile and/or the second frame profile subsequent a second set of said optical components 10. The first of said optical component 10 may positioned after every n^{th} second optical component, wherein n is a number between 5-10.

FIG. 6B shows the touch sensing apparatus as described above with reference to FIG. 6A. In FIG. 6B, a second optical component 10b is illustrated with a dotted line. The second optical component 10b is arranged at a second cross-section of the first frame profile 21, and therefore illustrated by dotted line. The second optical component 10b is arranged at a second reflector distance from the reflector surface 13. As visible in FIGS. 7A-D, adjacent printed circuit boards may be partly overlapping, but optical components are not arranged such that they would overlap each other.

FIGS. 7A-D shows embodiments of a frame profile as seen from a central portion of the front cover 3. In FIGS. 7A-D, the first frame profile 21 is shown as the frame profile in cross section. However, the disclosure below with reference to the first frame profile 21 is applicable also for the second frame profile 22. In other words, the second frame profile 22 may replace the first frame profile 21 in the disclosure below with reference to FIGS. 7A-D. In an example, both the first frame profile 21 and the second frame profile 22 is of the type described below with reference to FIGS. 7A-D.

The first frame profile 21 is provided with multiple attachment positions 31, 32, 33, 34, 35 for the optical components 10. The attachment positions 31, 32, 33, 34, 35 are positioned at different distances from the reflector surface 13.

FIG. 7A shows an example of the first frame profile 21, or the second frame profile 22, with multiple attachment positions 31, 32, 33, 34, 35. The multiple attachment positions 31, 32, 33, 34, 35 are provided as slots in the first frame profile 21, or the second frame profile 22. The slots are arranged at different distances from the reflector surface 13. In each slot, one or several printed circuit boards 40 may be attached. One or several optical components 10 such as emitters 12 and detectors 11 are arranged on the printed circuit boards 40. Adjacent printed circuit boards 40 may be connected to each other by a vertical board to board connector 41.

FIG. 7A shows several multiple attachments positions 31, 32, 33, 34, 35 provided in the form of a first slot, a second slot, a third slot, a fourth slot, and a fifth slot, arranged on the first frame profile 21.

A first optical component 10a is arranged on a first attachment position 31 in form of the first slot. The first optical component 10a is arranged at a first reflector distance d1 from the reflector surface 13 of the first frame profile 21. The first reflector distance d1 may be equal or less than or equal to 10 mm. In an example, the first optical component 10a is arranged at a distance of about 2.5-10 mm from the reflector surface 13.

A second optical component 10b is arranged on a second attachment position 32 in form of the second slot. The second optical component 10b is arranged at a second reflector distance d2 from the reflector surface 13 of the first frame profile 21. The second reflector distance d2 may be exceeding the first reflector distance d1. The second reflector distance d2 may be exceeding 10 mm. In an example, the second optical component 10b is arranged at a distance of about 10-15 mm from the reflector surface 13.

A third optical component 10c is arranged on a third attachment position 33 in form of the third slot. The third optical component 10c is arranged at a third reflector distance d3 from the reflector surface 13 of the first frame profile 21. The third reflector distance d3 may be exceeding the second reflector distance d2. The third reflector distance d3 may be exceeding 20 mm. In an example, the third optical component 10c is arranged at a distance of about 20-30 mm from the reflector surface 13.

A fourth optical component 10d is arranged on a fourth attachment position 34 in form of the fourth slot. The fourth optical component 10d is arranged at a fourth reflector distance d4 from the reflector surface 13 of the first frame profile 21. The fourth reflector distance d4 may be less than the third reflector distance d3. The fourth reflector distance d4 may be exceeding the first reflector distance d1. The fourth reflector distance d4 may be exceeding 10 mm. In an example, the fourth optical component 10d is arranged at a distance of about 10-15 mm from the reflector surface 13.

The first attachment position 31, the second attachment position 32, the third attachment position 33, and the fourth attachment position 34 are arranged below the rear surface 3b of the front cover 3. Consequently, the first optical component 10a, the second optical component 10b, the third optical component and the fourth optical component 10d are arranged below the rear surface 3b of the front cover 3.

A fifth optical component 10e is arranged on a fifth attachment position 35 in form of the fifth slot. The fifth attachment position 35 is arranged above the front surface 3a of the front cover 3.

The first frame profile 21 may be an extruded profile, such as an extruded metal profile, for example an extruded aluminium profile. The above described first, second and third slots may be formed in the extruded profile.

FIG. 7B shows an example of a first frame profile 21 provided with multiple attachment positions 31, 32, 33, 34, 35. The multiple attachment positions 31, 32, 33, 34, 35 are provided as slots in the first frame profile 21. The slots are arranged at different distances from the reflector surface 13. In each slot, one or several printed circuit boards 40 may be attached. One or several optical components 10 such as emitters 12 and detectors 11 are arranged on the printed circuit boards 40. Adjacent printed circuit boards 40 may be connected to each other by a vertical board to board connector 41.

In FIG. 7B, several attachment positions in form of a first, second, third, fourth, and fifth slot are provided at the first frame profile 21. The first, second, fourth and fifth slots are being inclined in respect of the reflector surface 13.

A first attachment position 31 in form of a first slot extends from a first reflector distance d1 from the reflector surface 13 to a second reflector distance d2 from the reflector surface 13, the first reflector distance d1 being less than the second reflector distance d2. Thereby, a first optical component 10a arranged on the first attachment position 31 may be arranged at a distance from the reflector surface 13 varying from a first reflector distance d1 to a second reflector distance d2.

A second attachment position 32 in form of a second slot extends from the second reflector distance d2 from the reflector surface 13 to a third reflector distance d3 from the reflector surface 13, the second reflector distance d2 being less than the third reflector distance d3. Thereby, a second optical component 10b arranged on the second attachment position 32 may be arranged at a distance from the reflector surface 13 varying from a second reflector distance d2 to a third reflector distance d3.

A third attachment position 33 in form of a third slot extends parallel with the reflector surface 13 at the third reflector distance d3 from the reflector surface. The third reflector distance d3 may be exceeding the second reflector distance d2. Thereby, a third optical component 10c arranged on the third attachment position 33 may be arranged at a third reflector distance d3 from the reflector surface 13.

A fourth attachment position 34 in form of a fourth slot extends from the third reflector distance d3 from the reflector surface 13 to a fourth reflector distance d4 from the reflector surface 13, the fourth reflector distance d4 being less than the third reflector distance d3. Thereby, a fourth optical component 10d arranged on the fourth attachment position 34 may be arranged at a distance from the reflector surface 13 varying from a third reflector distance d3 to a fourth reflector distance d4.

A fifth attachment position 35 in form of a fifth slot extends from the fourth reflector distance d4 from the reflector surface 13 to a fifth reflector distance d5 from the reflector surface 13, the fifth reflector distance d5 being less than the fourth reflector distance d4. Thereby, a fifth optical component 10e arranged on the fifth attachment position 35 may be arranged at a distance from the reflector surface 13 varying from a fourth reflector distance d4 to a fifth reflector distance d5.

In an example, the third reflector distance d3 may be exceeding 20 mm, and the first, second, fourth and fifth reflector distances may be less or equal to 20 mm. In an example, the first reflector distance d1 may be about 2.5-10 mm, the second reflector distance d2 may about 10-15 mm, the third reflector distance d3 may be about 20-30 mm, the fourth reflector distance d4 may be about 10-15 mmm, the fifth reflector distance d5 may be about 2.5-10 mm.

The first attachment position 31, the second attachment position 32, the third attachment position 33, the fourth attachment position 34, and the fifth attachment position 35 are arranged below the rear surface 3b of the front cover 3. Consequently, the first optical component 10a, the second optical component 10b, the third optical component 10c, the fourth optical component 10d, and the fifth optical component 10e are arranged below the rear surface 3b of the front cover 3.

The example shown in FIG. 7B may be combined with an attachment position, and an optical component, arranged above the front surface 3a of the front cover 3.

FIG. 7C shows an example of a first frame profile 21 provided with multiple attachment positions 31, 32, 33. The multiple attachment 31, 32, 33 positions are provided as slots in the first frame profile 21. The slots are arranged at different distances from the reflector surface 13. In each slot, one or several printed circuit boards 40 may be attached. One or several optical components 10 such as emitters 12 and detectors 11 are arranged on the printed circuit boards 40. Adjacent printed circuit boards 40 may be connected to each other by a vertical board to board connector 41.

In FIG. 7C, several attachment positions in form of a first, second and third slot are provided.

A first optical component 10a is arranged on a first attachment position 31 in form of the first slot. The first optical component 10a is arranged at a first reflector distance d1 from the reflector surface of the first frame profile 21. The first reflector distance d1 may be equal or less than or equal to 10 mm. In an example, the first optical component 10a is arranged at a distance of about 2.5-10 mm from the reflector surface 13.

A second optical component 10b is arranged on a second attachment position 32 in form of the second slot. The second optical component 10b is arranged at a second reflector distance d2 from the reflector surface 13 of the first frame profile 21. The second reflector distance d2 may be exceeding the first reflector distance d1. The second reflector distance d2 may be exceeding 10 mm. In an example, the second optical component 10b is arranged at a distance of about 10-15 mm from the reflector surface 13.

A third optical component 10c is arranged on a third attachment position 33 in form of the third slot. The third optical component 10c is arranged at a third reflector distance d3 from the reflector surface 13 of the first frame profile 21. The third reflector distance d3 may be exceeding the second reflector distance d2. The third reflector distance d3 may be exceeding 20 mm. In an example, the third optical component 10c is arranged at a distance of about 20-30 mm from the reflector surface 13.

In the example in FIG. 7C, adjacent printed circuit board 40 are connected to each other by a board to board connector 41 with long pins. The board to board connector 41 with long pins connects the printed circuit board 40 of the first optical component to the printed circuit board of the second optical component.

The first attachment position 31, the second attachment position 32, and the third attachment position 33 are arranged below the rear surface 3b of the front cover 3. Consequently, the first optical component 10a, the second optical component 10b, and the third optical component 10c are arranged below the rear surface 3b of the front cover 3.

FIG. 7D shows an example of a first frame profile 21 provided with contiguous surface for multiple attachment positions. The first frame profile 21 comprise a stamped sheet metal component 36 having a gap 38 forming a contiguous surface. The contiguous surface is curved. At a first position, the contiguous surface is arranged at a first reflector distance d1 from the reflector surface 13. The contiguous surface continuously extends from the first position to a second position arranged a second reflector distance d2 from the reflector surface 13. The second reflector distance d2 exceeds the first reflector distance d1. The contiguous surface continuously extends from the second position to a third position arranged a third reflector distance d3 from the reflector surface 13. The third reflector distance d3 is less than the second reflector distance d2. The third reflector distance d3 may equal the first reflector distance d1. The first reflector distance d1 and/or the third reflector distance d3 may be less or equal to 10 mm, such as being about 2.5-10 mm. The second reflector distance d2 may exceed first reflector distance d1 and/or the third reflector distance d3. The second reflector distance d2 may exceed 10 mm such as being about 10-15 mm.

Along the contiguous surface, several optical components 10 such as emitters 12 and/or detectors 11 may be arranged. Thereby, the optical components 10b, 10c, 10d are arranged at different distances from the reflector surface 13 of the first frame profile 21. The distance from the optical component 10 to the reflector surface 13 of the first surface may be continuously variable. Adjacent optical components 10 may be connected to each other by a vertical board to board connector.

Alternatively, stamped sheet metal component 36 may form a stepped surface having different levels, along which the optical components 10 may be arranged at different reflector distances from the reflector surface 13, similar to the arrangement in, for example 7A.

The arrangements disclosed with reference to FIGS. 7A-D may also be provided by more than one optical component 10 being arranged on the same printed circuit board 40. The printed circuit board 40 may be provided with positions arranged at different reflector distances from the reflector surface 13. A first optical component 10a may be arranged at a first reflector distance d1 from a first portion of the reflector surface 13 on a printed circuit board 40, a second optical component 10b may be arranged at a second reflector distance d2 from a second portion of the reflector surface 13 on the same printed circuit board 40, and a third component 10c may be arranged at a third reflector distance d3 from a third portion of the reflector surface 13 on the same printed circuit board 40.

In the description above with reference to FIG. 6A and to FIGS. 7A-D, the profile is described as a first frame profile 21. The profile may also be a second frame profile 22 as described above with reference to FIGS. 1-2. Both the first frame profile 21 and the second frame profile 22 may be provided with an arrangement of the type described above with reference to FIGS. 6 and 7A-D, wherein the optical components 10 are arranged at a variable distance from the reflector surface 13 of the first frame profile 21, or the second frame profile 22, respectively.

In an example of a touch sensing apparatus 1, the first frame profile 21 is of the type described above with reference to FIGS. 6 and 7A-D, and the second frame profile 22 is of the type described above with reference to FIGS. 6 and 7A-D. Consequently, optical components 10 of the first frame profile 21 may be arranged with a variable distance to the reflector surface 13 of the first frame profile 21. Optical components 10 of the second frame profile 22 may be arranged with a variable distance to the reflector surface 13 of the second frame profile 22. The first frame profile 21 may be provided with detectors 11. The second frame profile 22 may be provided with emitters 12. The first frame profile 21 may be free from emitters. The second frame profile 22 may be free from detectors.

In one example, the first frame profile 21 may comprise emitters 12 and detectors. The emitters 12 and the detectors may be intermittently arranged in the first frame profile 21. The second frame profile 22 may comprise emitters and detectors 11. The emitters and the detectors 11 may be intermittently arranged in the second frame profile 22.

The detectors 11 may be arranged in the first frame profile 21 with a mean distance between adjacent detectors 11 exceeding 10 mm, preferably exceeding 15 mm, more preferably exceeding 20 mm. The mean distance between adjacent detectors 11 may be in the range of 10-30 mm, preferably in the range of 10-20 mm.

The emitters 12 may be arranged in the second frame profile 22 with a mean distance between adjacent emitters 12 exceeding 10 mm, preferably exceeding 15 mm, more preferably exceeding 20 mm. The mean distance between adjacent emitters 12 may be in the range of 10-30 mm, preferably in the range of 10-20 mm.

In the first frame profile 21, at least one detector 11 may be arranged at distance exceeding 20 mm. In an example, a first set of the detectors 11 is arranged in the first frame profile 21 at a distance from the reflector surface 13 being equal to or less than 20 mm, and that a second set of the detectors 11 is arranged at a distance from the reflector surface 13 exceeding 20 mm.

In the second frame profile 22, at least one emitter 12 may be arranged at distance exceeding 20 mm. In an example, a first set of the emitters 12 is arranged in the second frame profile 22 at a distance from the reflector surface 13 being equal to or less than 20 mm, and that a second set of the emitters 12 is arranged at a distance from the reflector surface 13 exceeding 20 mm.

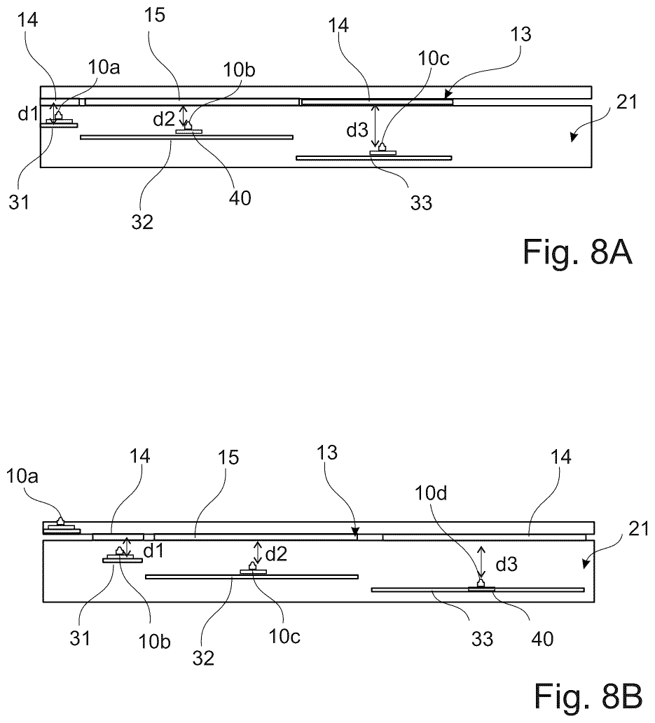

Furthermore, the first frame profile 21 may be of the type described above with reference to FIGS. 1-2, and/or FIGS. 3-5, and/or of the type described below with reference to FIGS. 8-B.

FIG. 8A shows an arrangement of optical components 10 such as detectors 11 and/or emitters 12 and a reflector surface 13 along a frame profile. The frame profile may be a first frame profile 21 and/or a second frame profile 22. The first frame profile 21 and/or the second frame profile 22 may be of the type described above with reference to FIGS. 1-2, and/or FIGS. 3-5, and/or FIGS. 6 and 7A-D.

In the below description, the frame profile will be described with reference to a first frame profile 21. However, the frame profile may be a second frame profile 22. In an example, both the first frame profile 21 and the second frame profile 22 is provided with a reflector surface 13 of the type described below.

The first frame profile 21 is provided with a reflector surface 13. The reflector surface 13 has at least on specular reflector portion 14 and at least one diffuser reflector portion 15.

Diffuser reflector portion is understood to mean a surface wherein at least 50% of the reflected light is diffusively reflected. Preferably, diffuser reflector portion 15, is designed to reflect incoming light such that at least about 60%, 70%, 80%, 90%, 95%, or 99% of the reflected light is diffusively reflected. The diffuser reflector portion 15 may be configured as an essentially ideal diffuse reflector, also known as a Lambertian or near-Lambertian diffuser, which generates equal luminance from all directions in a hemisphere surrounding the diffuser reflector portion 15. Many inherently diffusing materials form a near-Lambertian diffuser. In an alternative, the diffuser reflector portion 15 may be a so-called engineered diffuser, e.g. a holographic diffuser. An engineered diffuser reflector portion 15 may also be configured as a Lambertian diffuser. In a variant, the engineered diffuser reflector portion 15 is tailored to promote diffuse reflection into certain directions in the surrounding hemisphere, in particular to angles that provides for the desired propagation of light above and across the front cover 3.

The diffuser reflector portion 15 may be configured to exhibit at least 50% diffuse reflection, and preferably at least 90% diffuse reflection.

Many materials exhibit a combination of diffuse and specular reflection. Specularly reflected light may result in coupling losses between the emitter 12, detector 11 and the associated component therebetween. It is thus preferred that the relation between diffusive and specular reflection is high for the diffuser reflector portion 15. It is currently believed that reasonable performance may be achieved, at least for smaller touch sensing apparatuses 1, when at least 50% of the reflected light is diffusively reflected. Preferably, diffuser reflector portion 15, is designed to reflect incoming light such that at least about 60%, 70%, 80%, 90%, 95%, or 99% of the reflected light is diffusively reflected.

There are inherently diffusing materials that promote diffuse reflection into certain directions and that may be arranged on the reflector surface 13′, to form diffuser reflector portion 15. Thus, the diffuser reflector portion 15 may comprise a material of varying refractive index.

The diffuser reflector portion 15 may be implemented as a coating, layer or film applied to the reflector surface 13, e.g. by painting, spraying, lamination, gluing, etc.

In one example, the diffuser reflector portion 15 is implemented as matte white paint or ink applied to the reflector surface 13. In order to achieve a high diffuse reflectivity, it may be preferable for the paint/ink to contain pigments with high refractive index. One such pigment is TiO2, which has a refractive index n=2.8. I The properties of the paint may be further improved by use of EVOQUE™ Pre-Composite Polymer Technology provided by the Dow Chemical Company.

There are many other coating materials for use as a diffuser that are commercially available, e.g. the fluoropolymer Spectralon, polyurethane enamel, barium-sulphate-based paints or solutions, granular PTFE, microporous polyester, GORE® Diffuse Reflector Product, Makrofol® polycarbonate films provided by the company Bayer AG, etc.

Alternatively, the diffuser reflector portion 15 may be implemented as a flat or sheet-like device, e.g. the above-mentioned engineered diffuser or white paper, which is attached to the reflector surface 13 by an adhesive. According to other alternatives, the diffuser reflector portion 15, may be implemented as a semi-randomized (non-periodic) micro-structure on the reflector surface 13 with an overlying coating of reflective material.

The diffuser reflector portion 15 may also be incorporated into an internal surface at the reflector surface 13. For example, a micro-structure may be provided on the external or internal surfaces, by etching, embossing, moulding, abrasive blasting, etc. In another alternative, the diffuser reflector portion 15, may be light transmissive (e.g. a light transmissive diffusing material or a light transmissive engineered diffuser) and covered with a coating of reflective material.

Thus, the diffuser reflector portion 15 may comprise one of; white- or coloured paint, white- or coloured paper, Spectralon, a light transmissive diffusing material covered by a reflective material, diffusive polymer or metal, an engineered diffuser, a reflective semi-random micro-structure, in-moulded air pockets or film of diffusive material.

Specular reflector portions reflect light rays at an angle to the surface normal being essentially the same as the incident angle but on opposing side of the surface normal.

Diffuser reflector portions diffuses incident light rays at many angles and different from the incident angle, rather than in one direction as for the specular reflector portions.

A specular reflector portion 14 may be arranged adjacent a diffuser reflector portion 15. Specular reflector portions 14 and diffuser reflector portions 15 may be intermittently arranged along a longitudinal direction of the first frame profile 21. In an example (not shown), two or more specular reflector portions 14 are arranged adjacent each other, followed by at least one diffuser reflector portion 15. In an example (not shown), two or more diffuser reflector portions 15 are arranged adjacent each other, followed by at least one specular reflector portion 14.

In an example (not shown), a reflector surface arrangement comprising more than one type of reflector surfaces may be provided for an optical component. A diffuser reflector portion may be arranged closest to the optical component, followed by a specular reflector portion.

The type of reflector surface 13 may be chosen depending on the position of the reflector surface 13. In a corner of the frame 2, specular reflector portions 14 may be arranged. At a centre of the frame 2, diffuser reflector portions 15 may be arranged. In an example wherein the profile is the first frame profile 21 and/or the second frame profile 22, specular reflector portions 14 may be arranged adjacent the third frame profile 23 and/or the fourth frame profile 24. In an example of an embodiment, in a corner of the frame 2, diffuser reflector portions 15 may be arranged, and specular reflector portions 14 may be arranged at a centre of frame 2. When the profile is the first frame profile 21 and/or the second frame profile 22, diffuser reflector portions 15 may be arranged adjacent the third frame profile 23 and/or the fourth frame profile 24.

The first frame profile 21 is provided with optical components 10 such as emitters 12 and/or detectors 11. A ratio between a number of specular reflector portions 14 to a number of optical components 10 may be in the range of 1:5-1:50. A ratio between a number of diffuser reflector portions 15 to a number of optical components 10 may be in the range of 4:5-49:50.

The optical components 10 may be arranged with a mean distance between adjacent optical components 10 exceeding 10 mm, preferably exceeding 15 mm, more preferably exceeding 20 mm. The mean distance between adjacent optical components 10 may be in the range of 10-30 mm, preferably in the range of 10-20 mm.

Aa shown in FIG. 8A, the optical components 10 are arranged at a varying distance from the reflector surface 13. The optical components 10 may be emitters 12 and/or detectors 11. The optical components 10 are arranged below the rear surface 3b of the front cover 3.

A first optical component 10a is arranged at a first reflector distance d1 from a first portion of the reflector surface 13. The first optical component 10a may be arranged on a first attachment position 31 in form of a first slot in the first frame profile 21. The first portion of the reflector surface 13 may be a specular reflector portion 14.

A second optical component 10b is arranged at a second reflector distance d2 from a second portion of the reflector surface 13. The second optical component may be arranged on a second attachment position 32 in form of a second slot in the first frame profile 21. The second portion of the reflector surface 13 may be a diffuser reflector portion 15. The second reflector distance d2 may exceed the first reflector distance d1. The first reflector distance d1 may be less than the second reflector distance d2. In an example, the first reflector distance d1 may be less or equal to 10 mm, such as being about 2.5-10 mm. The second reflector distance d2 may be exceeding 10 mm such as being about 10-15 mm.

A third optical component 10c is arranged at a third reflector distance d3 from a third portion of the reflector surface 13. The third optical component 10c may be arranged on a third attachment position 33 in form of a third slot in the first frame profile 21. The third portion of the reflector surface 13 may be a specular reflector portion 14. The third reflector distance d3 may be less than the second reflector distance d2. The third reflector distance d3 may be equal or less than 10 mm, such as being about 2.5-10 mm.

In an example, the optical components 10 such as the first optical component the second optical component 10b, and the third optical component 10c are arranged at a substantially equal distance from the reflector surface 13. The first optical component 10a may be arranged at a distance from a specular reflector portion 14. The second optical component 10b may be arranged at a similar distance from a diffuser reflector portion 15. The third optical component 10c may be arranged at a similar distance from a specular reflector portion 14.

In an example, both the first frame profile 21 and the second frame profile 22 is of the type described above with reference to FIG. 8A with reflector surfaces 13 comprising specular reflector portions 14 and diffuser reflector portions 15. The optical components 10 provided at the first frame profile 21 may be detectors 11. The detectors 11 may be arranged at a varying distance from the reflector surfaces 13 comprising at least one specular reflector portion 14 and at least one diffuser reflector portion 15 as described above. The first frame profile 21 may be free from any emitters. The optical components 10 provided at the second frame profile 22 may be emitters 12. The emitters 12 may be arranged at a varying distance from the reflector surfaces 13 comprising at least one specular reflector portion 14 and at least one diffuser reflector portion 15 as described above. The second frame profile 22 may be free from any detectors. The first frame profile 21 and the second frame profile 22 may form long sides of the frame.

In one example, the first frame profile 21 may comprise emitters 12 and detectors. The emitters 12 and the detectors may be intermittently arranged in the first frame profile 21. The second frame profile 22 may comprise emitters and detectors 11. The emitters and the detectors 11 may be intermittently arranged in the second frame profile 22.

A mean distance between adjacent detectors 11 in the first frame profile 21 may be exceeding 10 mm, preferably exceeding 15 mm, more preferably exceeding 20 mm. A distance between adjacent emitters 12 in the second frame profile 22 may be exceeding 10 mm, preferably exceeding 15 mm, more preferably exceeding 20 mm. The mean distance between adjacent detectors 11 and/or emitters 12 may be in the range of 10-30 mm, preferably in the range of 10-20 mm.

FIG. 8B shows an arrangement of optical components 10 such as detectors 11 and/or emitters 12 and a reflector surface 13 along a frame profile. The frame profile may be a first frame profile 21 and/or a second frame profile 22. The first frame profile 21 and/or the second frame profile 22 may be of the type described above with reference to FIGS. 1-2, and/or FIGS. 3-5, and/or FIGS. 6 and 7A-D.

In the below description, the frame profile will be described with reference to a first frame profile 21. However, the frame profile may be a second frame profile 22. In an example, both the first frame profile 21 and the second frame profile 22 is provided with a reflector surface 13 of the type described below.

The first frame profile 21 is provided with a reflector surface 13. The reflector surface 13 has at least on specular reflector portion 14 and at least one diffuser reflector portion 15.

Specular reflector portions reflect light rays at an angle to the surface normal being essentially the same as the incident angle but on opposing side of the surface normal in the plane formed by the incident and reflected rays.

Diffuser reflector portions diffuses incident light rays at many angles and different from the incident angle and at wide angles rather than at just a narrow set of angled as in the case of specular reflection.

A specular reflector portion 14 may be arranged adjacent a diffuser reflector portion 15. Specular reflector portions 14 and diffuser reflector portions 15 may be intermittently arranged along a longitudinal direction of the first frame profile 21. In an example (not shown), two or more specular reflector portions 14 are arranged adjacent each other, followed by at least one diffuser reflector portion 15. In an example (not shown), two or more diffuser reflector portions 15 are arranged adjacent each other, followed by at least one specular reflector portion 14.

In an example (not shown), a reflector surface arrangement comprising more than one type of reflector surfaces may be provided for an optical component. A diffuser reflector portion may be arranged closest to the optical component, followed by a specular reflector portion.

The type of reflector surface 13 may be chosen depending on the position along the longitudinal direction of the first frame profile 21. In a corner of the frame 2, specular reflector portions 14 may be arranged. Alternatively, as will described below, an optical component 10 may be located above the front surface 3a of the front cover 3. For example, an optical component 10 may be located above the front surface 3a of the front cover 3 adjacent a corner of the frame 2. At a centre of the frame 2, diffuser reflector portions 15 may be arranged. In an example wherein the profile is the first frame profile 21 and/or the second frame profile 22, specular reflector portions 14, may be arranged adjacent the third frame profile 23 and/or the fourth frame profile 24. Alternatively, wherein the profile is the first frame profile 21 and/or the second frame profile 22, the optical components 10 such detectors 11 and/or emitters 12 are arranged above the front surface 3a of the front cover 3 adjacent the third frame profile 23 and/or the fourth frame profile 24.

In an example of an embodiment, in a corner of the frame 2, diffuser reflector portions 15 may be arranged and specular reflector portions 14 may be arranged at a centre of frame 2. When the profile is the first frame profile 21 and/or the second frame profile 22, diffuser reflector portions 15 may be arranged adjacent the third frame profile 23 and/or the fourth frame profile 24.

The first frame profile 21 is provided with optical components 10 such as emitters 12 and/or detectors 11. A ratio between a number of specular reflector portions 14 to a number of optical components 10 may be in the range of 1:5-1:50. A ratio between a number of diffuser reflector portions 15 to a number of optical components 10 may be in the range of 4:5-49:50.

The optical components 10 may be arranged with a distance between adjacent optical components 10 exceeding 20 mm, preferably exceeding 30 mm, more preferably exceeding 35 mm such as about 40 mm.

Aa shown in FIG. 8B, the optical components 10 are arranged at a varying distance from the reflector surface 13. The optical components 10 may be emitters 12 and/or detectors 11.

In FIG. 8B, a first optical component 10a is arranged above the front surface 3a of the front cover 3. The first optical component 10a may be arranged above the reflector surface 13. No reflector surface may be provided at the position of the first optical component. The first optical component 10a arranged above the front surface 3a of the front cover 3 may be located adjacent a corner of the frame 2.

A second optical component 10b is arranged at a first reflector distance d1 from a first portion of the reflector surface 13. The first portion of the reflector surface 13 may be a specular reflector portions 14. The first reflector distance d1 may be less or equal to 10 mm, such as being about 2.5-10 mm.

A third optical component 10c is arranged at second reflector distance d2 from a second portion of the reflector surface 13. The second portion of the reflector surface 13 may be a diffuser reflector portions 15. The second reflector distance d2 may exceed the first reflector distance d1. The second reflector distance d2 may be exceeding 10 mm, such as being about 10-15 mm.

A fourth optical component 10d is arranged at a third reflector distance d3 from a third portion of the reflector surface 13. The third portion of the reflector surface 13 may be a specular reflector portions 14. The third reflector distance d3 may be exceed the second reflector distance d2. The third reflector distance d3 may exceed 20 mm, such as being about 20-30 mm.

In an example, both the first frame profile 21 and the second frame profile 22 is of the type described above with reference to FIG. 8B with reflector surfaces 13 comprising specular reflector portions 14 and diffuser reflector portions 15. The optical components 10 provided at the first frame profile 21 may be detectors 11. The detectors 11 may be arranged at a varying distance from the reflector surfaces 13 comprising at least one specular reflector portions 14 and at least one diffuser reflector portions 15 as described above. The first frame profile 21 may be free from any emitters. The optical components 10 provided at the second frame profile 22 may be emitters 12. The emitters 12 may be arranged at a varying distance from the reflector surfaces 13 comprising at least one specular reflector portions 14 and at least one diffuser reflector portions 15 as described above. The second frame profile 22 may be free from any detectors. The first frame profile 21 and the second frame profile 22 may form long sides of the frame.

A mean distance between adjacent detectors 11 in the first frame profile 21 may be exceeding 10 mm, preferably exceeding 15 mm, more preferably exceeding 20 mm. A mean distance between adjacent emitters 12 in the second frame profile 22 may be exceeding 10 mm, preferably exceeding 15 mm, more preferably exceeding 20 mm. The mean distance between adjacent detectors 11 and/or emitters 12 may be in the range of 10-30 mm, preferably in the range of 10-20 mm.

### Examples

1. A touch sensing apparatus (1), comprising
   a frame (2) comprising at least a first frame profile (21),
   a front cover (3) arranged on the frame (2), the front cover (3) having a front surface (3a) and a rear surface (3b),
   a plurality of optical components (10) arranged on the first frame profile (21), the optical component (10) comprising at least one of an emitter (12) and/or a detector (11),
   a reflector surface (13) arranged on the first frame profile (21),
   wherein the optical components (10) are arranged at different reflector distances (Dᵣ) from the reflector surface (13) on the first frame profile (21).
2. The touch sensing apparatus (1) according to example 1, wherein the optical components (10) are arranged below the front surface (3a) of the front cover (3).
3. The touch sensing apparatus (1) according to example 1 or 2, wherein the reflector distance (Dᵣ) between the optical components (10) and the reflector surface (13) varies along the first frame profile (21).
4. The touch sensing apparatus (1) according to any one of examples 1-3 wherein the first frame profile (21) is provided with multiple attachments positions (31, 32, 33, 34, 35) for the optical components (10), wherein the attachments positions (31, 32, 33, 34, 35) are positioned at different reflector distances from the reflector surface (13).
5. The touch sensing apparatus (1) according to any one of examples 1-4, wherein at least one of the optical components (10) is arranged in the first frame profile (21) at a reflector distance (Dᵣ) from the reflector surface (13) exceeding 2.5 mm, preferably exceeding 5 mm, more preferably exceeding 10 mm.
6. The touch sensing apparatus (1) according to any one of examples 1-5, wherein a first set of the optical components (10) is arranged in the first frame profile (21) at a reflector distance (Dᵣ) from the reflector surface (13) equal to or less than 20 mm, and that a second set of the optical components (10) is arranged in the first frame profile (21) at a reflector distance (Dᵣ) from the reflector surface (13) exceeding 20 mm.
7. The touch sensing apparatus (1) according to any one of examples 1-6, wherein the optical components (10) are arranged in the first frame profile (21) with a mean distance between adjacent optical components (10) exceeding 10 mm, preferably exceeding 15 mm, more preferably exceeding 20 mm.
8. The touch sensing apparatus (1) according to any one of examples 1-7, wherein the frame (2) further comprises a second frame profile (22), comprising a plurality of optical components (10).
9. The touch sensing apparatus (1) according to any one of examples 1-8, wherein the first frame profile (21) is free from emitters.
10. The touch sensing apparatus (1) according to example 8 or 9, wherein the second frame profile (22) is free from detectors.
11. The touch sensing apparatus (1) according to any one of examples 1-10, wherein the optical components (10) are arranged on printed circuit boards (40) arranged in the first frame profile (21), wherein each printed circuit boards (40) is provided with one or more of said optical components (10).
12. The touch sensing apparatus (1) according to example 11, wherein adjacent optical components (10) are connected to each other by a vertical board to board connector (41).
13. The touch sensing apparatus (1) according to any one of examples 1-12, wherein the first frame profile (21) comprises a stamped sheet metal component (36), wherein the optical components (10) are arranged on said sheet metal component (36) at a contiguous and variable reflector distance from the reflector surface (13).
14. A touch sensing apparatus (1), comprising
   a frame (2) comprising at least a first frame profile (21) and a second frame profile (22), wherein the first frame profile (21) and the second frame profile (22) are oppositely arranged,
   a front cover (3) arranged on the frame (2) by the first frame profile (21) and the second frame profile (22), the front cover (3) having a front surface (3a) and a rear surface (3b),
   a display panel (26) arranged on the frame (2), and
   a plurality of detectors (11) arranged on first frame profile (21), and
   a plurality of emitters (12) arranged on the second frame profile (22),
   wherein the first frame profile (21) comprises a first frame lip (21a), and the second frame profile (22) comprises a second frame lip (22a), and
   wherein a first cover distance (D_{c}1) parallel to a normal to the front surface (3a) of the front cover (3) from the first frame lip (21a) to the front surface (3a) of the front cover (3) is exceeding a second cover distance (D_{c}2) parallel to a normal to the front surface (3a) of the front cover (3) from the second frame lip (22a) to the front surface (3a) of the front cover (3).
15. The touch sensing apparatus (1) according to example 14, wherein a sealing (22e) is arranged between the front surface (3a) of the front cover (3) and the second frame profile (22).
16. The touch sensing apparatus (1) according to example 15, wherein the front cover (3) is clamped between the second frame profile (22) and the sealing (22e).
17. The touch sensing apparatus (1) according to any one of examples 14-16, wherein the front cover (3) is arranged in a groove (21e) in the first frame profile (21).
18. The touch sensing apparatus (1) according to any one of examples 14-17, wherein an open aperture (21d) is provided in the first frame profile (21) from the first frame lip (21a) to a part of the first frame profile (21) enclosing the front cover (3) in a direction normal to the front surface (3a) of the front cover (3).
19. The touch sensing apparatus (1) according to any one of examples 14-18, wherein the first frame profile (21) and the second frame profile (22) form long sides of the frame (2).
20. The touch sensing apparatus (1) according to any one of examples 14-19, wherein the first frame profile (21) is free from emitters.
21. The touch sensing apparatus (1) according to any one of examples 14-20, wherein the second frame profile (22) is free from detectors.
22. The touch sensing apparatus (1) according to any one of example 14-21, wherein the detectors (11) are arranged in the first frame profile (21) with a mean distance between adjacent detectors (11) exceeding 10 mm, preferably exceeding 15 mm, more preferably exceeding 20 mm.
23. The touch sensing apparatus (1) according to any one of example 14-22, wherein the emitters (12) are arranged in the second frame profile (22) with a mean distance between adjacent emitters (12) exceeding 10 mm, preferably exceeding 15 mm, more preferably exceeding 20 mm.
24. A touch sensing apparatus (1), comprising
   a frame (2) comprising a first frame profile (21), a second frame profile (22), a third frame profile (23), and a fourth frame profile (24), wherein the first frame profile (21) and the second frame profile (22) form long sides of the frame (2), and the third frame profile (23) and the fourth frame profile (24) form short sides of the frame (2),
   a front cover (3) arranged on the frame (2), the front cover (3) having a front surface (3a) and a rear surface (3b),
   a display panel (26) arranged on the frame (2), and
   a plurality of detectors (11) arranged on first frame profile (21), and
   a plurality of emitters (12) arranged on the second frame profile (22),
   wherein at least a portion of the first frame profile (21) and at least a portion of the second frame profile (22) are adapted to act on the front cover (3) with a force in a first direction parallel with a normal of the front surface (3a) of the front cover (3), and
   wherein at least a portion of the third frame profile (23) and at least a portion of the fourth frame profile (24) are adapted to act on the front cover (3) with a force in a second direction, opposite the first direction.
25. The touch sensing apparatus (1) according to example 24, wherein the second direction is directed away from the front surface (3a) of the front cover (3).
26. The touch sensing apparatus (1) according to example 24 or 25, wherein the front cover (3) is concavely curved as seen from the front surface (3a) of the front cover (3).
27. The touch sensing apparatus (1) according to any one of examples 24-26, wherein the front cover (3) is arranged in a groove (21e) in the first frame profile (21).
28. The touch sensing apparatus (1) according to any one of examples 24-27, wherein the front cover (3) is clamped between a sealing (22e) and the second frame profile (22).
29. The touch sensing apparatus (1) according to any one of examples 24-28, wherein the third frame profile (23) and/or the fourth frame profile (24) contacts the rear surface (3b) of the front cover (3).
30. The touch sensing apparatus (1) according to any one of examples 24-29, wherein the first frame profile (21) is free from emitters.
31. The touch sensing apparatus (1) according to any one of examples 24-30, wherein the second frame profile (22) is free from detectors.
32. The touch sensing apparatus (1) according to any one of examples 24-31, wherein the third frame profile (23) and the fourth frame profile (24) are free from detectors and free from emitters.
33. The touch sensing apparatus (1) according to any one of examples 24-32, wherein the detectors (11) are arranged in the first frame profile (21) with a mean distance between adjacent detectors (11) exceeding 10 mm, preferably exceeding 15 mm, more preferably exceeding 20 mm.
34. The touch sensing apparatus (1) according to any one of examples 24-33, wherein the emitters (12) are arranged in the second frame profile (22) with a mean distance between adjacent emitters (12) exceeding 10 mm, preferably exceeding 15 mm, more preferably exceeding 20 mm.
35. The touch sensing apparatus (1) according to any one of examples 24-34, wherein the third frame profile (23) and/or the fourth frame profile (24) acts on the front cover (3) with a first force on a portion of the front cover (3) adjacent the first frame profile (21) and/or adjacent the second frame profile (22), and the third frame profile (23) and/or the fourth frame profile (24) acts on the front cover (3) with a second force on a central portion of the front cover (3), wherein the first force is exceeding the second force.
36. The touch sensing apparatus (1) according to any one of examples 24-35, wherein the third frame profile (23) and the fourth frame profile (24) are curved.
37. The touch sensing apparatus (1) according to any one of examples 24-36, wherein the first frame profile (21) and the second frame profile (22) are curved.
38. A touch sensing apparatus (1), comprising
   a frame (2) comprising at least a first frame profile (21),
   a front cover (3) arranged on the frame (2) by the first frame profile (21), the front cover (3) having a front surface (3a) and a rear surface (3b),
   a display panel (26) arranged on the frame (2), and
   a plurality of optical components (10) arranged on first frame profile (21), the optical component (10) comprising at least one of an emitter (12) and/or a detector (11), and
   wherein the first frame profile (21) comprises a reflector surface (13) having at least one specular reflector portion (14) and at least one diffuser reflector portion (15).
39. The touch sensing apparatus (1) according to example 38, wherein the optical components (10) are arranged below the front surface (3a) of the front cover (3).
40. The touch sensing apparatus (1) according to example 38 or 39, wherein a ratio between a number of specular reflector portions (14) to a number of optical components (10) is in the range of 1:5-1:50.

41. The touch sensing apparatus (1) according to any one of examples 38-40, wherein a ratio between a number of diffuser reflector portions (15) to a number of optical components (10) is in the range of 4:5-49:50.
42. The touch sensing apparatus (1) according to any one of examples 38-41, wherein the specular reflector portions (14) and the diffuser reflector portions (15) are intermittently arranged on the reflector surface (13).
43. The touch sensing apparatus (1) according to any one of examples 38-42, wherein at least one of said specular reflector portions (14) is arranged in the first frame profile (21) adjacent a corner of the frame (2).
44. The touch sensing apparatus (1) according to any one of examples 38-43, wherein the first frame profile (21) is free from emitters.
45. The touch sensing apparatus (1) according to any one of examples 38-44, wherein the second frame profile (22) is free from detectors.
46. The touch sensing apparatus (1) according to any one of examples 38-45, wherein the first frame profile (21) and the second frame profile (22) form long sides of the frame (2).
47. The touch sensing apparatus (1) according to any one of examples 38-46, wherein the optical components (10) are arranged in the first frame profile (21) with a mean distance between adjacent optical components (10) exceeding 10 mm, preferably exceeding 15 mm, more preferably exceeding 20 mm.

1. A touch sensing apparatus, comprising
a frame comprising a first frame profile, a second frame profile, a third frame profile, and a fourth frame profile, wherein the first frame profile and the second frame profile form long sides of the frame, and the third frame profile and the fourth frame profile form short sides of the frame,
a front cover arranged on the frame, the front cover having a front surface and a rear surface,
a display panel arranged on the frame, and
a plurality of detectors arranged on first frame profile, and
a plurality of emitters arranged on the second frame profile,
wherein at least a portion of the first frame profile and at least a portion of the second frame profile are adapted to act on the front cover with a force in a first direction parallel with a normal of the front surface of the front cover, and
wherein at least a portion of the third frame profile and at least a portion of the fourth frame profile are adapted to act on the front cover with a force in a second direction, opposite the first direction.

2. The touch sensing apparatus according to claim 1, wherein the second direction is directed away from the front surface of the front cover.

3. The touch sensing apparatus according to claim 1, wherein the front cover is concavely curved as seen from the front surface of the front cover.

4. The touch sensing apparatus according to claim 1, wherein the front cover is arranged in a groove in the first frame profile.

5. The touch sensing apparatus according to claim 1, wherein the front cover is clamped between a sealing and the second frame profile.

6. The touch sensing apparatus according to claim 1, wherein the third frame profile and/or the fourth frame profile contacts the rear surface of the front cover.

7. The touch sensing apparatus according to claim 1, wherein the first frame profile is free from emitters.

8. The touch sensing apparatus according to claim 1, wherein the second frame profile is free from detectors.

9. The touch sensing apparatus according to claim 1, wherein the third frame profile and the fourth frame profile are free from detectors and free from emitters.

10. The touch sensing apparatus according to claim 1, wherein the detectors are arranged in the first frame profile with a mean distance between adjacent detectors exceeding 10 mm.

11. The touch sensing apparatus according to claim 1, wherein the emitters are arranged in the second frame profile with a mean distance between adjacent emitters exceeding 10 mm.

12. The touch sensing apparatus according to claim 1, wherein the third frame profile and/or the fourth frame profile acts on the front cover with a first force on a portion of the front cover adjacent the first frame profile and/or adjacent the second frame profile, and the third frame profile and/or the fourth frame profile acts on the front cover with a second force on a central portion of the front cover, wherein the first force is exceeding the second force.

13. The touch sensing apparatus according to claim 1, wherein the third frame profile and the fourth frame profile are curved.

14. The touch sensing apparatus according to claim 1, wherein the first frame profile and the second frame profile are curved.
